(19) United States
(12) Patent Application Publication
(10) Pub. No.: US 2009/0096590 A1
(43) Pub. Date: Apr. 16, 2009

(54) AUTOMATIC PRODUCT EXPIRATION ALERT DEVICE

(75) Inventor: George P. Grundelman, Rockwall, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6731, US

(73) Assignee: INTER BASIC RESOURCES, INC., Grass Lake, MI (US)

(21) Appl. No.: 11/909,884

(22) PCT Filed: Mar. 29, 2006
(86) PCT No.: PCT/US2006/011484

§ 371 Date: May 15, 2008

Related U.S. Application Data
(60) Provisional application No. 60/667,763, filed on Apr. 1, 2005.

(51) Int. Cl. G08B 1/00; G08B 21/00

(52) U.S. Cl. 340/309.16; 340/540

(57) ABSTRACT

An automatic product (12) expiration alert device comprising a product (12) having a predetermined useful life and a package (14) covering at least a portion of the product (12). The act of opening the package (14) automatically energizes a timing device (16) to begin measuring the product (12) life. The timing device (16) has an inactivated an activated state. An initiator (18) is located proximate the package (14) and product (12). The initiator (18) is operably connected to the timing device (16) and movable between a first position and a second position when the package and timing device (16) are moved apart from each other The timing device (16) remains in the inactivated state when the initiator (18) is in the first position and the timing device (16) is in the activated state when the initiator (18) is in the second position. A signal alert (20) is in communication with the timing device (16) so that it produces a signal in response to the timing device (16) when the product (12) life has expired.

### RELATED APPLICATION DATA

This application claims the benefit of U.S. Provisional Patent Application No. 60/667,763, filed April 1, 2005, entitled “Product Expiration Alert Device,” which application is incorporated herein by reference.

### FIELD OF THE INVENTION

The present invention generally relates to the field of products with a finite life. In particular, the present invention is directed to an automatic device for alerting a user that one or more products have reached the end of their useful lifespan.

### BACKGROUND OF THE INVENTION

Many products used in business, at home and in other contexts have a limited or finite life. A product's useful life may expire at a specific time due to spoilage, usage of the product, or breakdown of product components. Usage of filters used to remove dust, dirt and other contaminants in the circulated air, for example, typically results in contaminated and dirty filters that may cause problems such as restricted or reduced air flow, system inefficiency, and difficulty in maintaining a desirable air temperature and air quality and, in extreme cases, system damage requiring costly repairs. Food, drugs, chemicals, and other time-sensitive products stored in containers often begin to spoil and/or deteriorate after the container is opened. While product expiration may pose a risk to consumers, devices and systems that use and depend on the product and should provide sufficient incentive for manufacturers and users to carefully monitor product life, such monitoring does not always occur due to other priorities, difficulties associated with the monitoring process, carelessness and other factors.

Manufacturers often provide notices, labels, pamphlets, or other information that may denote the useful and safe lifespan of a product including, among others, expiration dates on consumable food, drug and other time-sensitive products, and suggested replacement and maintenance schedules for the products. While these notices provide advanced notice of the product expiration, they often fail to capture the user's attention and go unheeded especially when products are out-of-sight and positioned within closed containers or sealed systems.

In addition, the expiration dates oftentimes do not accurately reflect the useful life of a product and may result in premature maintenance service, disposal and replacement of products. Many manufacturers and users, for example, statically measure the useful life of a product from its date of manufacture although the product life does not begin to expire until the product is removed from its container or package and put into use. Thus, the product may have a significantly longer life when it is stored or not being used for its designated purpose.

While certain devices have been used to assist users in determining product expiration, many product expiration devices are not self-initiating by the act of opening the product and require manual intervention to initiate a preprogrammed countdown that are often ignored by users, difficult to use, or complicated and expensive to manufacture. Failure to properly and timely initiate the countdown sequence results in incorrect calculation of product life. Existing devices also react adversely to changes in environmental factors (e.g., temperature and humidity) and can strain the accuracy of these devices, limiting the application to a narrow range of products. Other product expiration devices are applicable only for specific applications (e.g., a medicine bottle), and often cannot be used in other products or applications.

### SUMMARY OF THE INVENTION

An automatic product expiration alert device for a product having a pre-determined useful life is provided that automatically starts a timing device that measures the product life once a package covering at least a portion of the product is opened. The timing device has an inactivated and activated state, wherein the timing device determines the expiration of a product lifespan in the activated state. An initiator is located proximate to the package and product. The initiator is operably connected to the timing device and movable between a first position and a second position when the package and timing device are moved apart from each other. The timing device remains in the inactivated state when the initiator is in the first position but is in the activated state when the initiator is moved to the second position. A signal alert device in communication with or part of the timing device produces a signal in response to the timing device that alerts a user when the product life has expired. In one embodiment of the invention, the timing device comprises a power source that powers electronic circuitry that performs a timing sequence for determining the product expiration.

### BRIEF DESCRIPTION OF THE DRAWINGS

For the purpose of illustrating the invention, the drawings show a presently preferred form of the invention. However, it should be understood that the present invention is not limited to the precise arrangements and instrumentalities shown in the drawings, wherein:

FIG. 1 is a block diagram showing one embodiment of an automatic product expiration alert device made according to the present invention;

FIGS. 2-3 illustrate an exploded perspective view and a schematic diagram of one embodiment of an automatic product expiration alert device made according to the present invention;

FIGS. 4-12 are schematic diagrams showing alternative embodiments of an automatic product expiration alert device made according to the present invention.

### DETAILED DESCRIPTION OF PREFERRED EMBODIMENTS

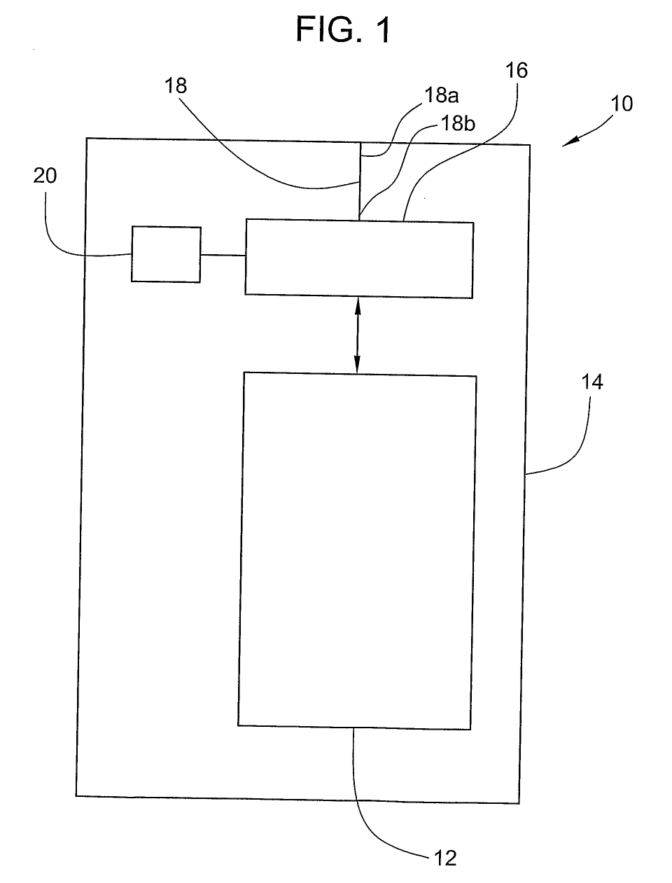

The present invention is directed to an automatic product expiration alert device 10 and method for alerting a user of the pending expiration of a product 12 having a predetermined lifespan. Referring to the drawings, wherein like reference numerals refer to like elements, FIG. 1 illustrates a block representation of one embodiment of the automatic product expiration alert device 10 made in accordance with the present invention that is self-initiating and automatically begins measuring the product life by the act of opening the product packaging. The act of opening the product packaging 14 may comprise opening a box, removing a plastic bag, removing at least a portion of a product wrapper from the product 12, sliding the product 12 out of a container, opening a lid or cover of a container, or removing a timing device 16 from the product 12 prior to installation or use of the product 12.

The automatic product expiration alert device 10 may comprise a package 14 that carries the product 12, a timing device 16 that measures product life (e.g., hours, days, weeks, months or longer), an initiator 18 that energizes the timing device 16 in response to the opening of the product packaging, and an alert signal device 20 in communication with the timing device 16 that signals when the product life has expired. The alert signal device 20, that may be an integral part of the timing device 16 or a separate component, provides a visual, auditory or other notification to the user that the suggested life of the product 12 has expired. The automatic product expiration alert device 10 may take one of numerous possible forms and the size and shape of the automatic product expiration alert device 10 may be configured so it may be attached to or become part of the specific product being timed. Those skilled in the art will appreciate the various types of materials, configurations and connections that may be used, such that exhaustive lists need not be provided for those skilled in the art to appreciate the broad scope of the present invention.

In the exemplary embodiment in FIG. 1, the initiator 18 automatically starts the timing device 16 when the package 14 is opened and the product 12 is removed from the package 14. The initiator 18 is movable between first and second positions. In the first position, a first end 18a of the initiator 18 is securely attached to the package 14 and the second end 18b is removably attached to the timing device 16. When the package 14 is opened, the initiator 18 is moved to the second position wherein the second end of initiator 18b separates from the timing device 16 and automatically initiates the timing sequence that measures the product expiration period without the need for other manual initiation of the timing device by the user. The timing device 16 operatively communicates with the alert signal device 20 so that the timing device 16 may inform the alert signal device 20 when the useful product life has expired. The timing device 16 and alert signal device 20 may remain attached to the product 12 or be removed from the product 12 and placed in a location easily monitored by the user. These applications capitalize on the ability of the timing device 16 to accurately determine the useful lifespan of the product 12 and the alert signal device 20 to notify the user at the expiration of the product 12.

The timing device 16 may comprise electronic circuitry 30 such as a microcontroller, microprocessor, application specific integrated circuits (ASIC), field programmable gate arrays (FPGA) or other integrated circuitry and electrical components such as a PIC10F200 device made by Microchip Technology Inc., Chandler, Ariz. Logic instructions stored on the electronic circuitry as firmware or software control operation of the timing device 16. Alternatively, the timing device 16 may be a chemical device, as shown for example, in U.S. Patent Application Publication US 2004/0240324 A1, a mechanical device, or any other device capable of determining when a selected period of time has elapsed. The timing device 16 may store and relay information about one or more predetermined time periods (e.g., hours, days, months and the like), a product's life expectancy, a product's replacement or cleaning schedule, product expiration dates and the like. The timing device 16 may be programmed to monitor multiple time periods and control the alert signal device 20 to generate a signal after each predetermined time period. Alternatively, the timing sequence may be manually selected by the end user.

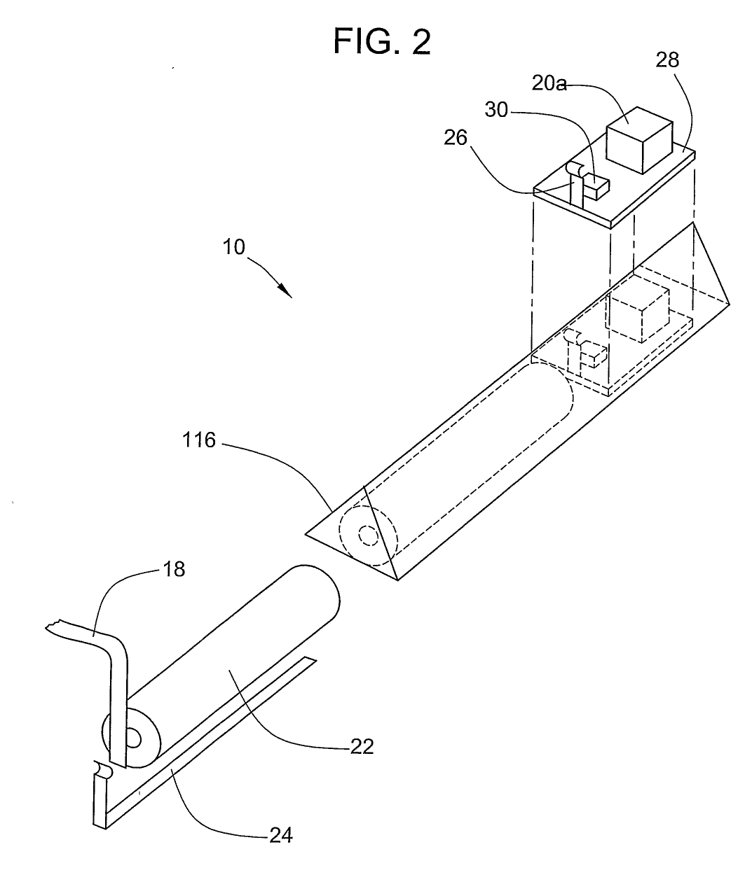

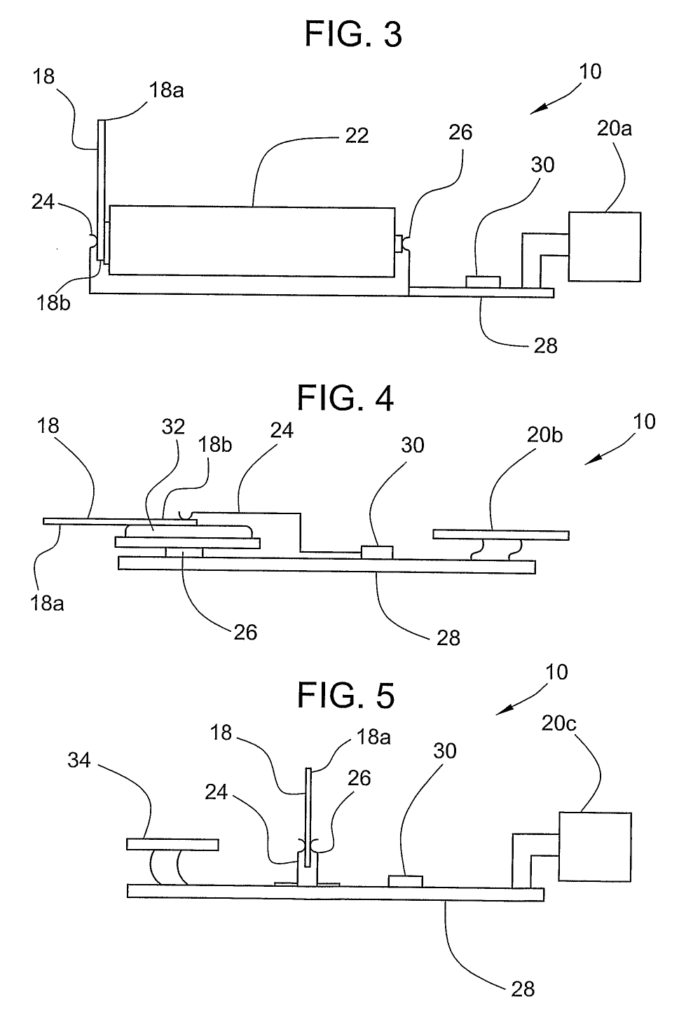

FIGS. 2-5 illustrate other configurations of the timing device 16, initiator 18 and alert signal device 20. For ease of reference, the product 12 and package 14 are not shown in FIGS. 2-5. In the embodiment of the automatic product expiration alert device 10 in FIGS. 2 and 3, the device 10 comprises a power source such as a cylindrical battery 22, a first contact 24 and a second contact 26. First contact 24 and second contact 26 are mechanically attached and electrically connected to a circuit board 28. Circuit board 28 also comprises an electronic circuitry 30 preprogrammed with a specific timing sequence. First contact 24 is electrically insulated and separated from battery 22 by the second end 18b of the initiator 18. The initiator 18 may be made of an electrically insulating material such as Dacron, nylon or polyethylene. As the initiator 18 is moved to the second position and the second end 18b of the initiator 18 is removed from between the first contact 24 and battery 22, an electrical connection between battery 22 and electronic circuitry 30 is made that initiates a preprogrammed timing sequence on the electronic circuitry 30 without the need for manual initiation of the timing device 16 by a user. Upon such initiation, the timing sequence may cause the alert signal device 20 to notify the user. In FIG. 2, the product expiration alert device 10 has a housing or case 116 for the other components. In FIGS. 2-3, the alert device is a light emitting diode 20a. The size and shape of housing 116 could be configured in order to attach to or become part of the specific product being timed.

Upon expiration of the preprogrammed time period, the timing device 16 communicates with an alert device 20 that generates a humanly perceptible alert signal to notify the user of the expiration of the timing period and the need to replace, service or discard the product 12. The alert device 20 may generate signals such as lights, audible sounds, tactile vibrations, printed displays, scent emitters, electronic transmissions, email, radio frequency transmissions, and the like and would operate for a sufficient period of time to assure that the user perceives the alert signal. The alert signal device 20, for example, may produce an intermittent blinking light or audible “beep” or “buzz” every few seconds for a specified period of time. Device 20 may then rest for a specified period of time to conserve the life of the power source 22, and then begin its alert sequence again. The alert sequence could repeat until the power source 22 is exhausted or until the user replaces the expired product 12 with a new one and restarts a new product expiration alert device 10. The length and type of notification could be easily programmed into electronic circuitry 30 and could be changed based on the type of product being timed.

Additional embodiments of the invention are shown in FIGS. 4-5. FIG. 4 illustrates another embodiment of an automatic product expiration alert device 10 that is identical to the embodiment shown in FIG. 3, except device 10 includes a coin battery 32 instead of a cylindrical battery 22. First contact 24 and second contact 26 are also constructed to contact coin battery 32 in place of battery 22. In FIG. 4, the signal alert device is a buzzer 20b that makes an audible sound.

FIG. 5 illustrates another embodiment of product expiration alert device 10 that is identical to the embodiment shown in FIGS. 2-4, except device 10 includes a solar cell 34 instead of a battery 22 or 32 and the signal alert device consists of tactile vibrator 20c. The solar cell 34 is connected to first and second contacts 24, 26. Separating the product 12 from package 14 exposes the solar cell 34 to light that generates electricity to power the electronic circuitry 30. Receipt of the electricity causes timing device 16 to begin timing sequence.

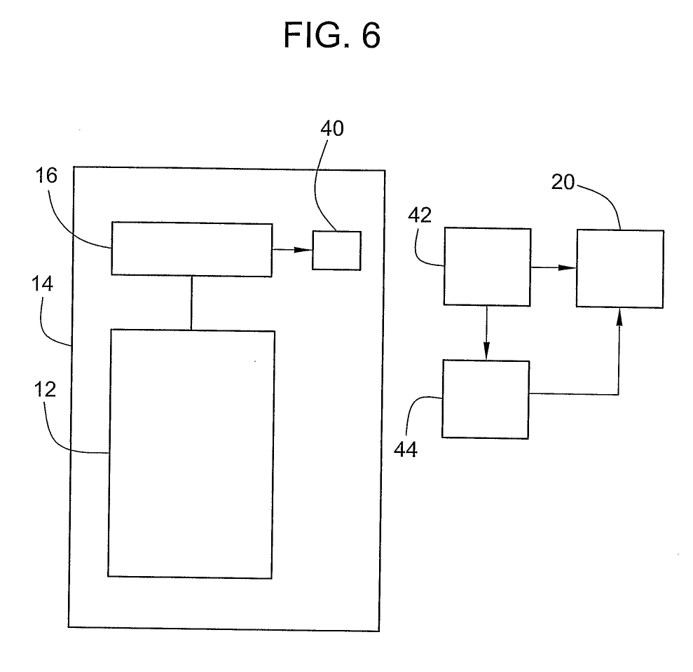

In the embodiment in FIGS. 2-5, the timing device 16 and alert signal device 20 are communicatively coupled, but may also communicate by conventional wireless technology. hi the exemplary embodiment in FIG. 6, the timing device 16 sends a signal to a transmitting device 40 indicating that the product has expired. The transmitting device 40 generates a conventional wireless signal by conventional radio frequency communication protocols such as 802.11 or Bluetooth® protocols. A remotely located receiver 42 receives the signal so that the signal alert device 20 may notify the user about the product expiration. Alternatively, the receiver 42 may communicate with a computer or computer network component 44 that generates an alert message such as an email or text message alert. By using wireless communication technology, the timing device 16 may communicate with a remotely located signal alert device 20. This is particularly advantageous when the product 12 and timing device 16 are located in a remote location from the user or normally out-of-sight of the user. In such circumstances, the alert device 20 may be located near to the user in a readily accessible location so that the user may monitor the alert device 20.

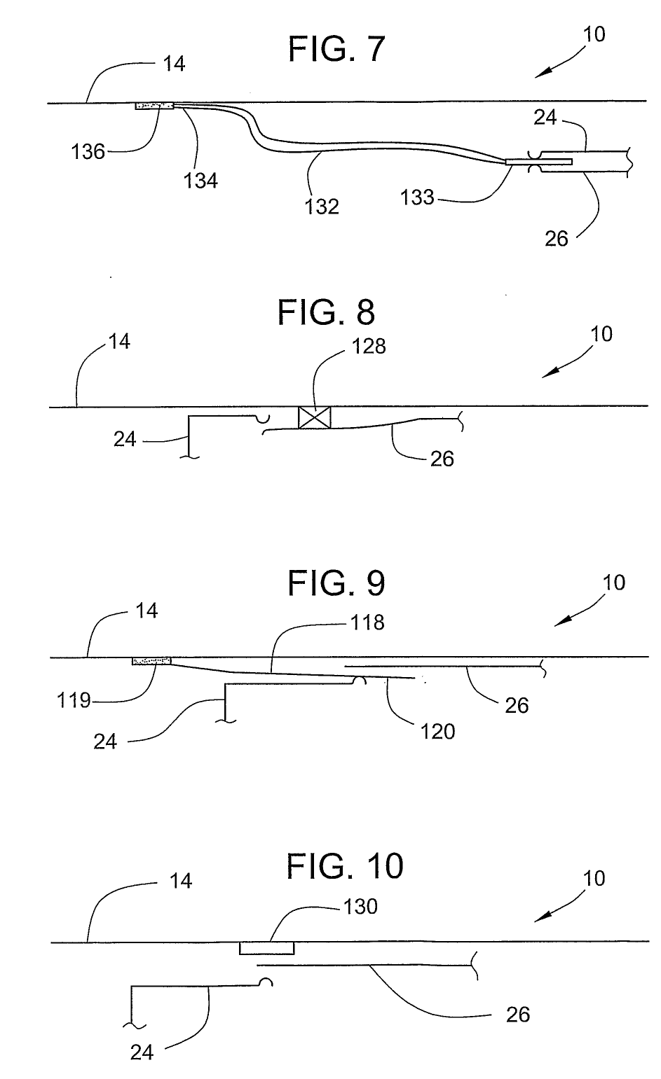

In accordance with the present invention, the process of opening a package 14 to use a product 12 may activate the timing device 16. FIGS. 7-13 provide some examples of possible physical configurations of the package 14 and initiator 18 (e.g., 128, 130, 132) to initiate the timing device 16. For ease of reference, the product 12 and alert device 20 are not shown. The product packaging 14 may be any product packaging known to persons skilled in the art including, for example, rigid or flexible containers with or without lids or covers, plastic or paper wrappers, shrink-wrap packages or sheets, cardboard containers, envelopes and re-closable bags and the like. A person skilled in the art, of course, will recognize from the present invention the numerous packaging possibilities such that an exhaustive list of examples need not be presented here. In the embodiment in FIG. 7, the initiator 132 is a flexible string-like element. In the first position, the initiator 132 has a first end 134 attached to the packaging by adhesive 136 or other suitable attachment means known to those skilled in the art. The initiator 132 has a second end 133 made of an electrically insulating material positioned between first contact 24 and second contact 26. In response to removal of the product 12 and product expiration alert device 10 from product packaging 14, the initiator 132 is moved to the second position and the second end 133 of the initiator 132 is also removed from between first contact 24 and second contact 26, thereby forming an electrical connection between the first and second contacts 24, 26 and initiating the preprogrammed timing sequence in the timing device 16 discussed above.

FIG. 8 illustrates another embodiment of the configuration for the product expiration alert device 10 and product packaging 14. In the first position shown in FIG. 8, the initiator in the form of a spacer 128 is attached to the product packaging 14 and separates first contact 24 and second contact 26. As the initiator is moved to the second position upon removal of product expiration alert device 10 from product packaging 14, the spring bias inherent in second contact 26 causes second contact 26 and first contact 24 to form an electrical connection, thereby powering the timing device 16 and initiating the preprogrammed timing sequence discussed above.

FIG. 9 illustrates another embodiment of the configuration for the product expiration alert device 10 and product packaging 14. In the first position shown in FIG. 9, the first end 119 of the initiator 118 is attached to the packaging 14 and the second end 120 separates first contact 24 and second contact 26. As the initiator is moved to the second position upon removal of the product and product expiration alert device 10 from product packaging 14, the initiator 118 is removed from between first contact 104 and second contact 106, thereby powering the timing device 16 and initiating the preprogrammed timing sequence discussed above.

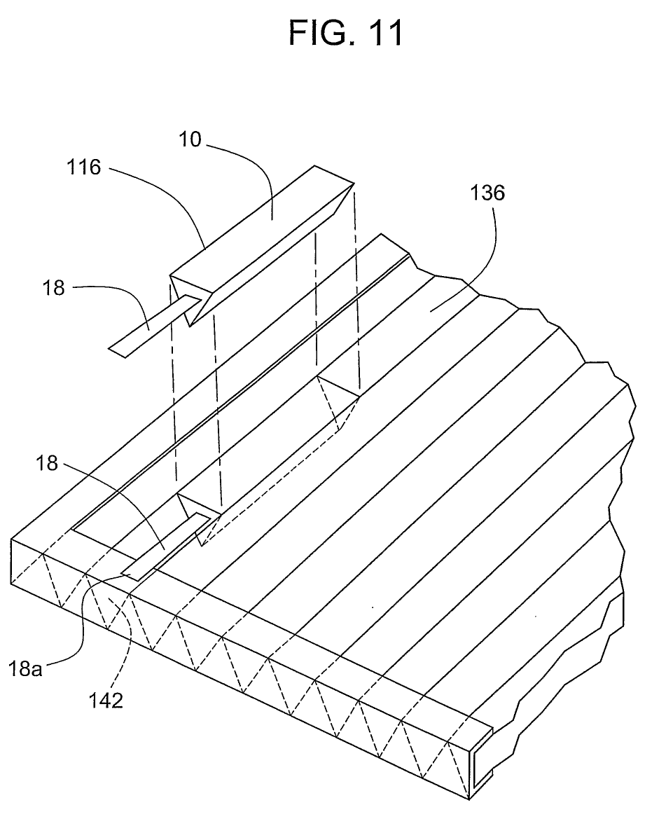

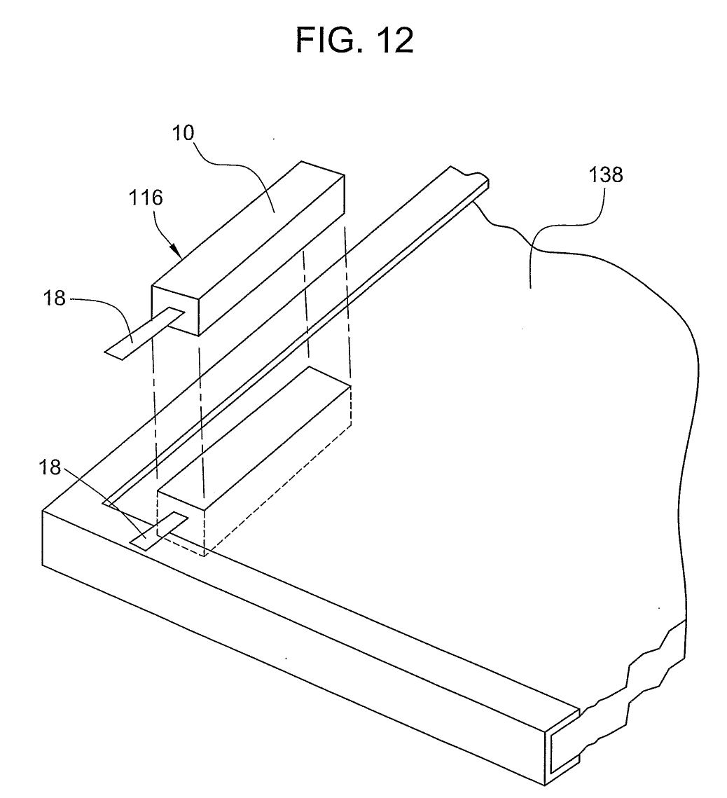

FIG. 10 illustrates another embodiment of the configuration of product expiration alert device 10 and product packaging 14. First contact 24 is made of an electrically conductive non-ferromagnetic material and second contact 26 is made of an electrically conductive ferromagnetic material. In the first position shown in FIG. 10, an initiator 18 in the form of a magnet 130 is attached to product packaging 14. The magnetic forces exerted by magnet 130 on second contact 26 urge second contact 26 away from first contact 24. As the initiator is moved to the second position upon removal of product expiration alert device 10 from product packaging 14, the magnet 130 is removed, permitting the spring bias inherent in second contact 26 to form an electrical connection with the second contact 26. The electrical connection powers the timing device 16 and initiates the preprogrammed timing sequence discussed above. When the first contact 24 is also made of a ferromagnetic material, the magnet 130 should exert a sufficient force 130 to keep the second contact 26 sufficiently separated until the device 10 is separated from the packaging 14.

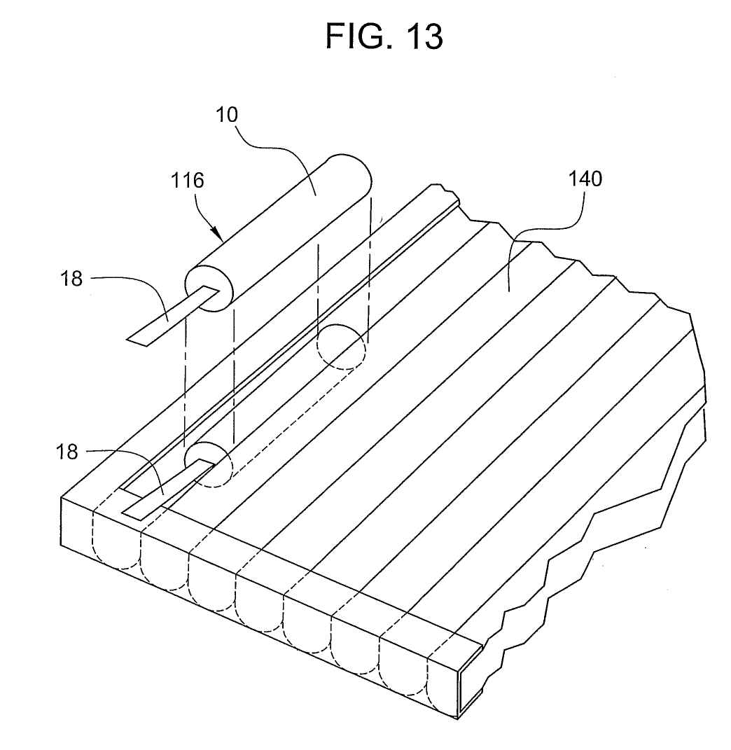

It will be appreciated that the product expiration alert device 10 may be used with any product such that device 10 does not interfere with the use or operation of the product. The present invention is applicable to many products, and particularly applicable to products such as air, water, oil and other filters that have a limited life span and need to be replaced according to a predetermined schedule. FIGS. 11-13 illustrate how the housing 116 of the automatic product expiration alert device 10 may be sized and shaped to fit within the pleats 142 of conventional pleated filters 136, 138, 140. In this regard, the cross-sectional size and configuration of the housing 116 is selected to conform closely to the cross-sectional configuration of a given pleat 134. The housing 116 may be removably attached to pleated filter 136 using adhesive bonding or other conventional attachment means. FIG. 11 shows the first portion of the initiator 18 wherein one end 18a of the initiator 18 is attached to the filter. Prior to installation of the filter into a filtration system, the product expiration device 10 is removed from the filter, thereby moving the initiator to the second position and separating the initiator 18 from the device 10. It will be appreciated that many filters are used in closed systems or placed in remote locations (e.g., in a basement or under a sink) that are not readily accessible to the user and where alerts provided by timing device 16 and signal alert device 20 may not be noticeable by a user. Once separated from the filter, however, the product expiration device 10 may be placed in a location where the alert signal 20 is readily accessible and noticeable to the user.

In other applications, the automatic product expiration alert device 10 may also be used to monitor the expiration of foods, beverages, medications, chemicals and other products that have a defined life span after the product container is opened. The device 10 is located proximate to the package 14 or product container so that the initiator 18 may be attached to the lid or cover of the container. As the cover is removed, the indicator activates the timing device 20 as discussed above.

Although the invention has been described and illustrated with respect to exemplary embodiments thereof, it should be understood by those skilled in the art that the foregoing and various other changes, omissions and additions may be made therein and thereto, without parting from the spirit and scope of the present invention. It should be understood that the present invention is not limited to any particular embodiment of the invention, but rather is intended to cover all systems and methods that fairly fall within the broad scope of the appended claims.

What is claimed is:

1. An automatic product expiration alert device for a product having a predetermined life, the automatic product expiration alert device comprising:
a package covering at least a portion of the product;
a timing device having an inactivated and activated state that determines when the product lifespan has expired in the activated state; and
an initiator proximate the package and product and operably connected to the timing device, wherein the initiator is movable between a first position and a second position when the package and timing device are moved apart from each other, and wherein the timing device remains in the inactivated state when the initiator is in the first position and the timing device is energized in the activated state when the initiator is moved to the second position; and
a signal alert device that produces a signal indicating that the product life has expired in response to the timing device.

2. The automatic product expiration alert device as set forth in claim 1 wherein the timing device comprises electrical circuitry coupled to a power source so that electrical circuitry performs a timing sequence for determining the product expiration in response to power from the power source.

3. The automatic product expiration alert device as set forth in claim 2 wherein the timing device comprises an electrical contact that couples the electrical circuitry and the power source, and wherein, in the first state, the initiator comprises a first end attached to the package and a second end that insulates the battery and contact and prevents current flow to the electrical circuitry until the second end is removed when the initiator is in the second position.

4. The automatic product expiration alert device as set forth in claim 2 wherein the power source is a battery.

5. The automatic product expiration alert device as set forth in claim 2 wherein the power source is a solar cell.

6. The automatic product expiration alert device as set forth in claim 2 wherein the initiator comprises a magnet and the timing device comprises first and second electrical contacts capable of coupling the electrical circuitry and power source,
wherein the second contact is movable between activated and inactivated positions so that the first and second contacts do not couple the electrical circuitry and power source in the inactivated position, and the first and second contacts couple the electrical circuitry and power source in the inactivated position, and
wherein the magnetic force of the magnet holds the second contact in the inactivated position when the magnet is in the first position and releases the second contact so that the first and second contacts may contact each other when the magnet is in the second position.

7. The automatic product expiration alert device as set forth in claim 1 comprising a transmitting device and a receiving device, wherein the timing device sends a signal to a transmitting device when the product life has expired so that the transmitting device may send a wireless signal to a remotely located receiver connected to the signal alert device.

8. The automatic product expiration alert device as set forth in claim 1 comprising a transmitting device and a receiving device, wherein the timing device sends a signal to the transmitting device when the product life has expired so that the transmitting device may send a wireless signal to the remotely located receiving device connected to a computer network component capable of generating an alert message that the product life has expired.

9. The automatic product expiration alert device as set forth in claim 1 wherein the timing device is releasably attached to the product.

10. The automatic product expiration alert device as set forth in claim 1 wherein the alert device is a light emitting element.

11. A system according to claim 1 wherein the alert device is a tactile vibrator.

12. A system according to claim 1 wherein the alert device is a sound emitting element.

13. An automatic product expiration alert device comprising:
a product having a predetermined life;
a package covering at least a portion of the product;
a timing device having an inactivated and activated state that determines when the product lifespan has expired in the activated state; and
an initiator proximate the package and product and operably connected to the timing device, wherein the initiator is movable between a first position and a second position when the package and timing device are moved apart from each other, and wherein the timing device remains in the inactivated state when the initiator is in the first position and the timing device is energized in the activated state when the initiator is moved to the second position; and
a signal alert device that produces a signal indicating that the product life has expired in response to the timing device.

14. The automatic product expiration alert device as set forth in claim 13 wherein the timing device comprises electrical circuitry coupled to a power source so that electrical circuitry performs a timing sequence for determining the product expiration in response to power from the power source.

15. The automatic product expiration alert device as set forth in claim 14 wherein the timing device comprises an electrical contact that couples the electrical circuitry and the power source, and wherein, in the first state, the initiator comprises a first end attached to the package and a second end that insulates the battery and contact and prevents current flow to the electrical circuitry until the second end is removed when the initiator is in the second position.

16. A method of providing an alert that the life of a product has expired, the method comprising the steps of attaching a timing device to the product, wherein the timing device has an activated state that determines when the product lifespan has expired and an inactivated state; and
attaching an initiator proximate the product and timing device, wherein the initiator is movable between a first position and a second position when the product and timing device are moved apart from each other, and wherein the timing device remains in the inactivated state when the initiator is in the first position and the timing device is energized in the activated state when the initiator is moved to the second position;
activating the timing device by moving the initiator from the first position to the second position to begin timing the life of the product;
operatively connecting to the timing device a signal alert device that produces a signal indicating that the product life has expired in response to the timing device; and
providing an alert from the alert device when the timing device determines that the life of the product has expired.

17. A method according to claim 16 further comprising the step of removing the alert device from the product and placing the alert device in location remotely located from the product.

18. A method according to claim 16 further comprising the steps of placing a transmitting device connected to the timing device in a first location;
placing a receiving device connected to the alert device in a second location accessible to a user; and
sending a signal from the timing device to the transmitting device when the product life has expired so that the transmitting device may send a wireless signal to the remotely located receiver connected to the signal alert device.

19. A method according to claim 16 further comprising the steps of placing a transmitting device connected to the timing device in a first location;
placing a receiving device in a second location connected to a computer network component capable of generating an alert message that the product life has expired; and
sending a signal from the timing device to the transmitting device when the product life has expired so that the transmitting device may send a wireless signal to the remotely located receiver connected to the signal alert device.
